(19) United States
(12) Patent Application Publication
(10) Pub. No.: US 2024/0029675 A1
(43) Pub. Date: Jan. 25, 2024

(54) DISPLAY DEVICE AND DRIVING METHOD THEREOF

(71) Applicant: Wuhan China Star Optoelectronics Technology Co., Ltd., Wuhan (CN)

(72) Inventors: Zhou ZHANG, Wuhan (CN); Changwen MA, Wuhan (CN); Pan XU, Wuhan (CN); Guowei ZHA, Wuhan (CN)

(21) Appl. No.: 17/613,964

(22) PCT Filed: Oct. 13, 2021
(86) PCT No.: PCT/CN2021/123487

§ 371 Date: Nov. 24, 2021

(30) Foreign Application Priority Data
Sep. 29, 2021 (CN) 20211151545.9

(51) Int. Cl. G09G 3/34; G09G 3/36

(52) U.S. Cl. CPC G09G 3/3426; G09G 3/3607; G09G 2320/0626; G09G 2320/0666

(57) ABSTRACT

The present disclosure provides a display device and a driving method thereof. A plurality of backlight partitions and a plurality of display partitions are arranged in a one-to-one correspondence, each backlight partition independently provides backlight for a corresponding display partition, and the backlight partition corresponding to each display partition is turned off in a scanning phase and a liquid crystal deflection phase, and is turned on in a light-emitting phase. While brightness requirements of a display device with high-resolution are met, a display effect of the display device is better.

### FIELD OF INVENTION

The present disclosure relates to the field of display technologies, and particularly to a display device and a driving method thereof.

### BACKGROUND OF INVENTION

At present, virtual reality (Virtual Reality, VR) technology is in a phase of rapid development. When high-resolution virtual reality equipment is assembled of liquid crystal display devices, backlight brightness of a backlight module of the liquid crystal display devices driven in a traditional way cannot meet brightness requirements of high-resolution liquid crystal display panels, which Specifically affects display of virtual reality devices in turn.

Therefore, it is necessary to provide a technical solution to solve a problem that the backlight module of the liquid crystal display device cannot meet brightness requirements of high-resolution display devices when the backlight brightness of a backlight module of the liquid crystal display devices is driven in a traditional way.

### SUMMARY

A purpose of present disclosure is to provide a display device and a driving method for the display device to solve a problem that a backlight module of a liquid crystal display device cannot meet brightness requirements of the high-resolution display devices when backlight brightness of the backlight module of the liquid crystal display device is driven in a traditional way.

In order to achieve the above purpose, the technical solutions are as follows:

A display device, comprising:
a display panel, wherein a display area of the display panel comprises a plurality of display partitions arranged in sequence along a scanning direction, each of the display partitions is configured to display a corresponding partition image, and phases of a display partition displaying the corresponding partition image comprise a scanning phase, a liquid crystal deflection phase, and a light-emitting phase, and
a backlight module, wherein a backlight area of the backlight module comprises a plurality of backlight partitions arranged in sequence along the scanning direction, the plurality of backlight partitions are arranged in a one-to-one correspondence with the plurality of the display partitions, each of the plurality of backlight partitions independently provides backlights for a corresponding one of the plurality of display partitions, and each of the plurality of backlight partitions is provided with a plurality of light-emitting elements;
Wherein, in the scanning phase, sub-pixels in the plurality of display partitions receive corresponding display data, in the liquid crystal deflection phase, the display panel controls liquid crystal to deflect to a preset state according to the display data, and in the light-emitting phase, backlight emitted from the plurality of backlight partitions corresponding to the plurality of display partitions passes through the liquid crystal in the preset state, so that the plurality of display partitions displays the corresponding partition images, and
Wherein, when each of the plurality of display partitions displays the corresponding partition image, the plurality of light-emitting elements in the backlight partitions corresponding to the plurality of display partitions are turned off in the scanning phase and the liquid crystal deflection phase, and at least one of the plurality of light-emitting elements in the plurality of backlight partition corresponding to the display partition is turned on in the light-emitting phase.

A driving method for a display device, wherein the display device includes a display panel and a backlight module, a display area of the display panel comprises a plurality of display partitions arranged in sequence along a scanning direction, each of the display partitions is configured to display a corresponding partition image, and phases of a display partition displaying the corresponding partition image includes a scanning phase, a liquid crystal deflection phase, and a light-emitting phase, a backlight area of the backlight module includes a plurality of backlight partitions arranged in sequence along the scanning direction, the plurality of backlight partitions are arranged in a one-to-one correspondence with the plurality of the display partitions, each of the plurality of backlight partitions independently provides backlights for a corresponding one of the plurality of display partitions, and each of the plurality of backlight partitions is provided with a plurality of light-emitting elements, and the driving method includes:
turning off the plurality of light-emitting elements in the backlight partitions corresponding to the plurality of display partitions in the scanning phase and the liquid crystal deflection phase when each of the plurality of display partitions displays a corresponding partition image and turning on at least one of the plurality of light-emitting elements in the backlight partition corresponding to the display partition in the light-emitting phase, and
sub-pixels in the plurality of display partitions receiving corresponding display data in the scanning phase, the display panel controlling liquid crystal to deflect to a preset state according to the display data in the liquid crystal deflection phase, and backlight emitted from the plurality of backlight partitions corresponding to the plurality of display partitions passes through the liquid crystal in the preset state in the light-emitting phase to make the plurality of display partitions display the corresponding partition images.

This present disclosure provides a display device and a driving method thereof, by enabling each backlight partition to independently provide backlight for a corresponding display partition, and the backlight partition is turned off when the corresponding display partition is in the scanning phase and the liquid crystal deflection phase, when the corresponding display partition is turned on in the light-emitting phase, the backlight partition provides enough time to provide the backlight when displaying each partition image to meet the backlight brightness requirements of each display partition, and ensure the liquid crystal has enough time for deflecting to make the display effect of the display device with a high resolution is better, and make the response time of the displayed dynamic images is lower.

### DESCRIPTION OF DRAWINGS

FIG. 1 is a schematic view of a display device according to an embodiment of the present disclosure.

FIG. 2 is a schematic view of each display partition and each backlight partition.

FIG. 3 is a driving timing view of the display device shown in FIG. 1.

### DETAILED DESCRIPTION OF EMBODIMENTS

The technical solutions in the embodiments of the present disclosure will be clearly and completely described below in conjunction with the drawings in the embodiments of the present disclosure. Obviously, the described embodiments are only a part of the embodiments of the present disclosure, rather than all the embodiments. Based on the embodiments in this disclosure, all other embodiments obtained by those skilled in the art without creative work shall fall within the protection scope of this application.

In traditional technology, a backlight module is in a continuous light-emitting state, and brightness of the backlight module has a limitation. However, as resolution of liquid crystal display panels continues to increase, the brightness limitation of the backlight module cannot meet brightness requirements of the liquid crystal display panels with high-resolution. In view of this problem, this present disclosure make a display area of a display panel include a plurality of display partitions arranged in sequence along a scanning direction, the backlight area of the backlight module comprise a plurality of backlight partitions arranged in sequence along the scanning direction, the plurality of backlight partitions be arranged in a one-to-one correspondence with the plurality of display partitions, and make each backlight partition independently provide backlight for a corresponding display partition, light-emitting elements in the backlight partitions corresponding to the display partitions are turned off when each of the display partitions is in a scanning phase and a liquid crystal deflection phase, that is, the backlight partition does not emit light, and at least one of the light-emitting elements in the backlight partitions corresponding to the display partitions is turned on when each of the display partitions is a light-emitting phase. In this way, light-emitting time and non-light-emitting time of each backlight partition can be adjusted to meet brightness requirements of each display partition, and a liquid crystal deflection time is sufficient to Specifically ensure a display effect, and a response time of a dynamic image of the display panel is also shortened, which is beneficial to make the liquid crystal display device with high resolution be applied to virtual reality equipment.

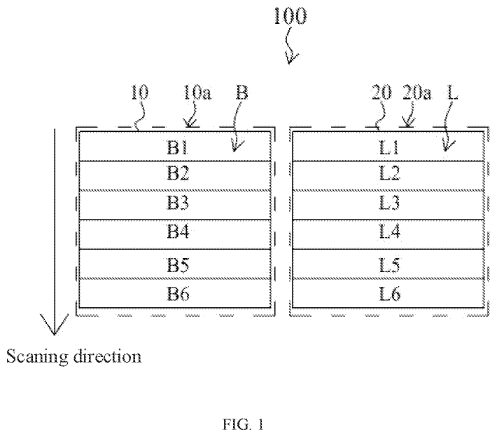

Please refer to FIG. 1, which is a schematic view of a display device according to an embodiment of the present disclosure. The display device 100 is a liquid crystal display device. The display device 100 includes a display panel 10 and a backlight module 20. The display panel 10 is located on a light-emitting side of the backlight module 20. The display panel 10 is a liquid crystal display panel.

In an embodiment of the present disclosure, the display panel 10 is composed of an array substrate, a color filter substrate, and liquid crystals located between the array substrate and the color filter substrate. The display panel 10 has no color filter layer, that is, no color filter layers are provided on both the array substrate and the color filter substrate. The display panel 10 has a display area 10a. The display area 10a of the display panel 10 includes a plurality of display partitions B sequentially arranged along a scanning direction of the display panel 10. The scanning direction points from one side of the display panel 10 to another side of the display panel 10, and each display partition B displays a corresponding partition image, and the plurality of display partitions are the same. That is, the plurality of display partitions B have same sizes and a number and arrangement of sub-pixels in each display partition B are the same. Specifically, taking a number of the display partitions B being 6 as an example, in the scanning direction of the display panel 10, the plurality of display partitions B are sequentially named a display partition B1, a display partition B2, a display partition B3, a display partition B4, and a display partition B5, and a display partition B6. It is understandable that, the number of the display partitions can be 2, 4, 5, 7, 8, and other numbers.

In an embodiment of the present disclosure, a phase of time of each display partition B displaying the corresponding partition image is composed of a scanning phase, a liquid crystal deflection phase, and a light-emitting phase. Wherein, in the scanning phase, sub-pixels in the plurality of display partitions B receive corresponding display data; in the liquid crystal deflection phase, the display panel 10 controls the liquid crystals to deflect to a preset state according to the display data, the liquid crystal in the preset state can ensure that the liquid crystal meets the requirements of light transmission; and in the light-emitting phase, light emitted from the plurality of backlight partitions corresponding to the plurality of display partitions passes through the liquid crystals deflected to the preset state to emit corresponding light, so that each display partition displays a partition image.

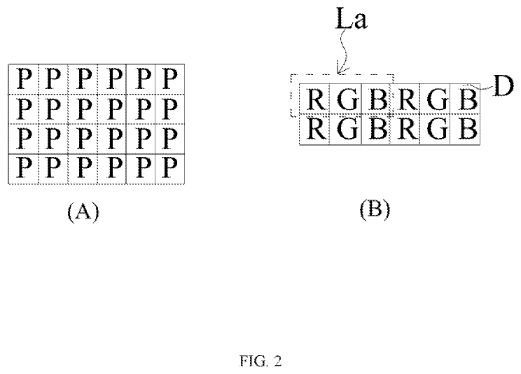

As shown in FIG. 2, it is a schematic view of each display partition and each backlight partition. As shown in FIG. 2(A), each display partition B is provided with a plurality of rows of sub-pixels P. A plurality of sub-pixels P in the plurality of rows of sub-pixels P are all single-dot sub-pixels. The plurality of sub-pixels P are the same. The single-dot sub-pixels are all square-shaped. Compared with a traditional pixel unit composed of red sub-pixels, blue sub-pixels, and green sub-pixels with a color film layer, when areas of pixel units are the same, a number of the single-dot sub-pixels is three times a number of sub-pixels in a conventional pixel unit.

Specifically, each display partition B includes the plurality of rows of sub-pixels P, for example, each display partition B includes two rows of sub-pixels P, three rows of sub-pixels P, and three or more rows of sub-pixels P. Wherein, in the scanning phase, the plurality of rows of sub-pixels P in each display partition B sequentially and continuously receive display data along the scanning direction row by row, after the plurality of rows of sub-pixels in each display partition B receive corresponding display data, in the liquid crystal deflection phase, the liquid crystals corresponding to each display partition B are deflected to a preset state, in the light-emitting phase, the liquid crystals deflected to the preset state corresponding to each display partition B receives backlight corresponding to the backlight partition, so that the display partition displays the corresponding partition image.

In an embodiment of the present disclosure, one frame of the display device 100 is divided into a plurality of different sub-frames, and the plurality of different sub-frames respectively display images with different colors of light. Specifically, one frame of the display device 100 is divided into three different sub-frames, namely, a red sub-frame, a green sub-frame, and a blue sub-frame, respectively. It can be understood that, one frame of the display device 100 may also be divided into four different sub-frames or five different sub-frames.

In an embodiment of the present disclosure, the backlight module 20 has a backlight area 20a. The backlight area 20a of the backlight module 20 includes a plurality of backlight partitions L arranged in sequence along the scanning direction. The plurality of backlight partitions L are the same, and the plurality of backlight partition L are arranged in a one-to-one correspondence with the plurality of display partitions B. Each backlight partition L is provided with at least one row of light-emitting elements D. At least one row of light-emitting elements D includes a plurality of light-emitting elements emitting light of different colors. Each backlight partition L is independently provides backlight for one corresponding display partition B. When each display partition B is in the scanning phase and the liquid crystal deflection phase, the plurality of light emitting elements D in the backlight partition L corresponding to the display partition B are all turned off, that is, the backlight partition L does not emit light and is in a black insertion state. When each display partition B is in the light-emitting phase, at least one light-emitting element in the backlight partition L is turned on to provide backlight for the corresponding display partition B, and the display partition B displays the corresponding partition image.

Specifically, when a number of the display partitions is 6, a number of the backlight partitions is also 6. In the scanning direction of the display panel, the plurality of backlight partitions are sequentially named a backlight partition L1, a backlight partition L2, a backlight partition L3, a backlight partition L4, a backlight partition L5, and a backlight partition L6. Wherein, the backlight partition L1 and the display partition B1 are set correspondingly to independently provide backlight for the display partition B1, the backlight partition L2 and the display partition B2 are set correspondingly to independently provide the backlight for the display partition B2, the backlight partition L3 and the display partition B3 are set correspondingly to independently provide backlight for display partition B3, backlight partition L4 and display partition B4 are set correspondingly to independently provide backlight for display partition B4, backlight partition L5 and display partition B5 are set correspondingly to independently provide backlight for display partition B5, and backlight partition L6 and the display partition B6 is set correspondingly to independently provide backlight for the display partition B6.

As shown in FIG. 2(B), each backlight partition L is provided with first light-emitting elements R emitting red light, second light-emitting elements G emitting green light, and third light-emitting elements B emitting blue light. Wherein, the light-emitting elements may be a miniature light-emitting diode or a sub-millimeter light-emitting diode. It is understandable that each backlight partition L may also be provided with light-emitting elements emitting other colors light, such as light-emitting elements emitting yellow light. Wherein, when the first light-emitting elements R in each backlight partition L are turned on, the plurality of rows of sub-pixels P in a display partition B corresponding to the backlight partition L receive the red light emitted from the first light-emitting element R, and the display partition B displays a partition image of a red sub-frame. When the second light-emitting elements G in each backlight partition L are turned on, the plurality of rows of sub-pixels P in a display partition B corresponding to the backlight partition L receive the green light emitted from the second light-emitting element G, and the display partition B displays a partition image of a green sub-frame. When the third light-emitting elements B in each backlight partition L are turned on, the plurality of rows of sub-pixels P in a display partition B corresponding to the backlight partition L receive the blue light emitted from the third light-emitting element B, and the display partition B displays a partition image of a blue sub-frame.

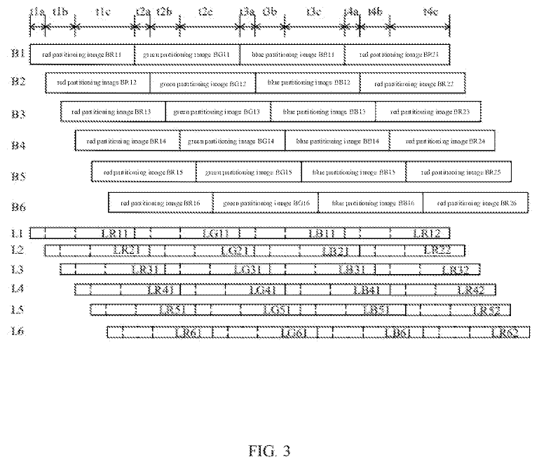

As shown in FIG. 3, it is a driving timing view of the display device shown in FIG. 1. Each display partition B of the display panel 10 sequentially displays partition images corresponding to different sub-frames in a preset order, and a plurality of partition images sequentially displayed from the plurality of display partitions B of the display panel 10 along the scanning direction form a same sub-frame. Wherein, multiple different sub-frames include red sub-frames, green sub-frames, and blue sub-frames, and the preset order is the red sub-frame, the green sub-frame, and the blue sub-frame. Frequencies of the red sub-frames, the green sub-frames, and the blue sub-frames are all 180 Hz. Frequency of one frame of the display panel 10 is 60 Hz.

Specifically, in the first frame, the display partition B1 successively displays a red partition image BR11, a green partition image BG11, and a blue partition image BB11. After the display partition B1 displays the red partition image BR11, the green partition image BG11 is displayed. After the green partition image BG11 is displayed, the blue partition image BB11 is displayed. Wherein, as shown in the LR11 phase in FIG. 3, the phase of the red partition image BR11 consists of a scanning phase t1a, a liquid crystal deflection phase t1b, and a light-emitting phase t1c in sequence. The plurality of light-emitting elements (including the first light emitting element R, the second light emitting element G, and the third light emitting element B) in the backlight partition L1 are turned off in the scanning phase t1a and the liquid crystal deflection phase t1b, and the first light-emitting element R in the backlight partition L1 is turned on in the light-emitting phase t1c. As shown in the LG11 phase in FIG. 3, the phase of the green partition image BG11 consists of a scanning phase t2a, a liquid crystal deflection phase t2b, and a light-emission phase t2c in sequence. The plurality of light-emitting elements in the backlight partition L1 are turned off in the scanning timr phase t2a and the liquid crystal deflection phase t2b. The second light-emitting element G in the backlight partition L1 is turned on in the light-emitting phase t2c. As shown in the LB11 phase in FIG. 3, the phase of the blue partition image BB11 consists of a scanning phase t3a, a liquid crystal deflection phase t3b, and a light-emitting phase t3c. The plurality of light-emitting elements in the backlight partition L1 are all turned off in the scanning phase t3a and the liquid crystal deflection phase t3b, and the third light-emitting element B in the backlight partition L1 is turned on in the light-emitting phase t3c. The scanning phase t1a, the scanning phase t2a, and the scanning phase t3a are equal, the liquid crystal deflection phase t1b, the liquid crystal deflection phase t2b, and the liquid crystal deflection phase t3b are equal, and the light-emitting phase t1c, the light-emitting phase t2c, and the light-emitting phase t3c are equal. The display partition B2 sequentially displays the red partition image BR12, the green partition image BG12, and the blue partition image BB12 in a same manner as the display partition B1. The scanning phase of the red partition image BR12 starts after the scanning phase t1a of the red partition image BR11 is over. The display partition B3, the display partition B4, the display partition B5, and the display partition B6 can be deduced by analogy, which will not be described in detail here. In addition, in the same display partition B, after the plurality of rows of sub-pixels sequentially receive the display data of the partition image corresponding to the red sub-frame along the scanning direction, the plurality of rows of sub-pixels then sequentially receive the display data of the partition image corresponding to the green sub-frame along the scanning direction, and then, the plurality of rows of sub-pixels receive the display data corresponding to the partition image corresponding to the blue sub-frame along the scanning direction, that is, when a same display partition sequentially displays the partition images corresponding to different sub-frames in a preset order, the plurality of rows of sub-pixels continuously receive the display data corresponding to the partition images of different sub-frames along the scanning direction.

In an embodiment of the present disclosure, along the scanning direction, the plurality of rows of sub-pixels P in the plurality of display partitions B sequentially and successively receive the display data corresponding to a same sub-frame row by row, wherein the plurality of rows of sub-pixels in each display partition receive the display data of the sub-frame corresponding to the display partition. For example, after the plurality of rows of sub-pixels P in the display partition B1 sequentially receive the display data of the red sub-frames corresponding to the display partition B1 along the scanning direction row by row, the plurality of rows of sub-pixels P in the display partition B2 sequentially receive the display data of the red sub-frames corresponding to the display partition B2 along the scanning direction row by row. After the plurality of rows of sub-pixels P in the display partition B2 receive the display data of the red sub-frames corresponding to the display partition B2, the plurality of rows of sub-pixels P in the display partition B3 sequentially receive the display data of the red sub-frames corresponding to the display partition B3 along the scanning direction row by row. After the plurality of rows of sub-pixels P in the display partition B3 receive the display data of the red sub-frames corresponding to the display partition B3, the plurality of rows of sub-pixels P in the display partition B4 sequentially receive the display data of the red sub-frames corresponding to the display partition B4 along the scanning direction row by row. After the plurality of rows of sub-pixels P in the display partition B4 receive the display data of the red sub-frames corresponding to the display partition B4, the plurality of rows of sub-pixels P in the display partition B5 sequentially receive the display data of the red sub-frames corresponding to the display partition B5 along the scanning direction row by row. After the plurality of rows of sub-pixels P in the display partition B5 receive the display data of the red sub-frames corresponding to the display partition B5, the plurality of rows of sub-pixels Pin the display partition B6 sequentially receive the display data of the red sub-frames corresponding to the display partition B6 along the scanning direction row by row.

In the scanning direction, the red partition image BR11 displayed by the display partition B1, the red partition image BR12 displayed by the display partition B2, the red partition image BR13 displayed by the display partition B3, the red partition image BR14 displayed by the display partition B4, the red partition image BR15 displayed by the display partition B5, and the red partition image BR16 displayed by the display partition B6 form the red sub-frame of the first frame. The green partition image BG11 displayed by the display partition B1, the green partition image BG12 displayed by the display partition B2, the green partition image BG13 displayed by the display partition B3, the green partition image BG14 displayed by the display partition B4, the green partition image BG15 displayed by the display partition B5, and the green partition image BG16 displayed by the display partition B6 form the green sub-frame of the first frame. The blue partition image BB11 displayed by the display partition B1, the blue partition image BB12 displayed by the display partition B2, the blue partition image BB13 displayed by the display partition B3, the blue partition image BB14 displayed by the display partition B4, the blue partition image BB15 displayed by the display partition B5, and the blue partition image BB16 displayed by the display partition B6 form the blue sub-frame of the first frame. The red partition image BR21 displayed by the display partition B1, the red partition image BR22 displayed by the display partition B2, the red partition image BR23 displayed by the display partition B3, the red partition image BR24 displayed by the display partition B4, the red partition image BR25 displayed by the display partition B5, and the red partition image BR26 displayed by the display partition B6 form the red sub-frame of the second frame. And the green sub-frame and the blue sub-frame of the second frame are not shown, and will not be described in detail here.

In addition, combined with FIG. 3, we can see, in the scanning phase and the liquid crystal deflection phase of the red partition image BR11 of the first frame, the first light-emitting element R, the second light-emitting element G, and the third light-emitting element B in the backlight partition L1 are all turned off. The light-emitting phase of the red partition image BR11 of the first frame corresponds to a turn-on phase LR11 of the first light-emitting element R in the backlight partition L1. In the scanning phase and the liquid crystal deflection phase of the red partition image BR12 of the first frame, the first light-emitting element R, the second light-emitting element G, and the third light-emitting element B in the backlight partition L2 are all turned off. The light-emitting phase of the red partition image BR12 of the first frame corresponds to a turn-on phase LR21 of the first light-emitting element R in the backlight partition L2. In the scanning phase and the liquid crystal deflection phase of the red partition image BR13 of the first frame, the first light-emitting element R, the second light-emitting element G, and the third light-emitting element B in the backlight partition L3 are all turned off. The light-emitting phase of the red partition image BR13 of the first frame corresponds to a turn-on phase LR31 of the first light-emitting element R in the backlight partition L3. In the scanning phase and the liquid crystal deflection phase of the red partition image BR14 of the first frame, the first light-emitting element R, the second light-emitting element G, and the third light-emitting element B in the backlight partition L4 are all turned off. The light-emitting phase of the red partition image BR14 of the first frame corresponds to a turn-on phase LR41 of the first light-emitting element R in the backlight partition L4. In the scanning phase and the liquid crystal deflection phase of the red partition image BR15 of the first frame, the first light-emitting element R, the second light-emitting element G, and the third light-emitting element B in the backlight partition L5 are all turned off. The light-emitting phase of the red partition image BR15 of the first frame corresponds to a turn-on phase LR51 of the first light-emitting element R in the backlight partition L5. In the scanning phase and the liquid crystal deflection phase of the red partition image BR16 of the first frame, the first light-emitting element R, the second light-emitting element G, and the third light-emitting element B in the backlight partition L6 are all turned off. The light-emitting phase of the red partition image BR16 of the first frame corresponds to a turn-on phase LR61 of the first light-emitting element R in the backlight partition L6. The light-emitting phase of the green partition image BG11 of the first frame corresponds to a turn-on phase LG11 of the second light-emitting element G in the backlight partition L1. The light-emitting phase of the green partition image BG12 of the first frame corresponds to a turn-on phase LG21 of the second light-emitting element G in the backlight partition L2. The light-emitting phase of the green partition image BG13 of the first frame corresponds to a turn-on phase LG31 of the second light-emitting element G in the backlight partition L3. The light-emitting phase of the green partition image BG14 of the first frame corresponds to a turn-on phase LG41 of the second light-emitting element G in the backlight partition L4. The light-emitting phase of the green partition image BG15 of the first frame corresponds to a turn-on phase LG51 of the second light-emitting element G in the backlight partition L5. The light-emitting phase of the green partition image BG16 of the first frame corresponds to a turn-on phase LG61 of the second light-emitting element G in the backlight partition L6. The light-emitting phase of the blue partition image BB11 of the first frame corresponds to a turn-on phase LB11 of the third light-emitting element B in the backlight partition L1. The light-emitting phase of the blue partition image BB12 of the first frame corresponds to a turn-on phase LB21 of the third light-emitting element B in the backlight partition L2. The light-emitting phase of the blue partition image BB13 of the first frame corresponds to a turn-on phase LB31 of the third light-emitting element B in the backlight partition L3. The light-emitting phase of the blue partition image BB14 of the first frame corresponds to a turn-on phase LB41 of the third light-emitting element B in the backlight partition L4. The light-emitting phase of the blue partition image BB15 of the first frame corresponds to a turn-on phase LB51 of the third light-emitting element B in the backlight partition L5. The light-emitting phase of the blue partition image BB16 of the first frame corresponds to a turn-on phase LB61 of the third light-emitting element B in the backlight partition L6. The light-emitting phase of the red partition image BR21 of the second frame corresponds to a turn-on phase LR12 of the first light-emitting element R in the backlight partition L1. The light-emitting phase of the red partition image BR22 of the second frame corresponds to a turn-on phase LR22 of the first light-emitting element R in the backlight partition L2. The light-emitting phase of the red partition image BR23 of the second frame corresponds to a turn-on phase LR32 of the first light-emitting element R in the backlight partition L3. The light-emitting phase of the red partition image BR24 of the second frame corresponds to a turn-on phase LR42 of the first light-emitting element R in the backlight partition L4. The light-emitting phase of the red partition image BR25 of the second frame corresponds to a turn-on phase LR52 of the first light-emitting element R in the backlight partition L5. The light-emitting phase of the red partition image BR26 of the second frame corresponds to a turn-on phase LR62 of the first light-emitting element R in the backlight partition L6.

In an embodiment of the present disclosure, two adjacent sub-frames of a same frame are displayed independently in space and overlapped in time. For example, the partition images of the red sub-frames that make up the first frame and the partition image of the green sub-frames that make up the first frame are displayed independently in space and overlapped in time, and the partition images of the blue sub-frames that make up the first frame and the partition images of the green sub-frames that make up the first frame are displayed independently in space and overlapped in time. The partition images of two adjacent different sub-frames that form two adjacent frames are displayed independently in space and overlapped in time. For example, the partition images of the blue sub-frame of the first frame and the partition images of the red sub-frame of the second frame are displayed independently in space and overlapped in time.

In an embodiment of the present disclosure, the plurality of backlight partitions include a first backlight partition and a second backlight partition. The first backlight partition and the second backlight partition respectively provide backlights for the partition images of two different sub-frames at the same time. The two different sub-frames may be two different sub-frames of a same frame. Wherein, there is at least another one backlight partition is arranged between the first backlight partition and the second backlight partition. For example, in the first frame, while the first light-emitting element R in the backlight partition L5 provides the red backlight in the light-emitting phase of the red partition image BR15, the second light-emitting element G in the backlight partition L1 provides the green backlight in the light-emitting phase of the green partition image BG11. Alternatively, while the first light-emitting element R of the backlight partition L6 provides the red backlight in the light-emitting phase of the red partition image BR16, the second light-emitting element G of the backlight partition L2 provides the green backlight in the light-emitting phase of the green partition image BG12.

In an embodiment of the present disclosure, the plurality of backlight partitions include a first backlight partition and a second backlight partition. The first backlight partition and the second backlight partition are respectively provide backlights for the partition images of two adjacent different sub-frames of two adjacent frames at the same time. For example, while the third light-emitting element B in the backlight partition L5 provides the blue backlight for the blue partition image BB15 of the first frame, and the first light-emitting element R in the backlight partition L1 provides the red backlight for the red partition image BR21 of the second frame.

In an embodiment of the present disclosure, the plurality of display partitions include a first display partition and a second display partition. The plurality of backlight partitions include a first backlight partition corresponding to the first display partition and a second backlight partition corresponding to the second display partition. When the first display partition and the second display partition respectively display partition images of two different sub-frames at the same time, the light-emitting elements in the first backlight partition and the second backlight partition are turned off at the same time. Two different sub-frames are two different sub-frames of a same frame. The first backlight partition and the second backlight partition are adjacently arranged.

Specifically, when the phase of the partition image displayed by the first display partition is in the liquid crystal deflection phase and the phase of the partition image displayed by the second display partition is in the scanning phase, the plurality of light-emitting elements in the first backlight partition and the plurality of light-emitting elements in the second backlight partition are turned off at the same time. For example, when the display partition B1 displays the red partition image BR11, the light-emitting elements in the backlight partition L1 corresponding to the display partition B1 are turned off in the liquid crystal deflection phase t1b, the display partition B2 displays the red partition image BR12, and the light-emitting elements in the partition L2 corresponding to the display partition B2 are turned off in the scanning phase.

In an embodiment of the present disclosure, the plurality of display partitions include a first display partition and a second display partition. The plurality of backlight partitions include a first backlight partition corresponding to the first display partition and a second backlight partition corresponding to the second display partition. When the first display partition and the second display partition respectively display partition images in a same sub-frames at the same time, at least one of the light-emitting elements in the first backlight partition is turned on, and the light-emitting elements in the second backlight partition are turned off at the same time. The first backlight partition and the second backlight partition are adjacently arranged.

Specifically, when the phase of the partition image displayed by the first display partition is in the light-emitting phase and the phase of the partition image displayed by the second display partition is in the liquid crystal deflection phase, at least one of the plurality of light-emitting elements in the first backlight partition is turned on, and the plurality of light-emitting elements in the second backlight partition are turned off at the same time. For example, in the light-emitting phase of the red partition image BR11 and the liquid crystal deflection phase of the red partition image BR12, while the first light emitting element R in the backlight partition L1 corresponding to the display partition B1 is turned on, the light-emitting elements in the backlight partition L2 adjacent to the backlight partition L1 and corresponding to the display partition B2 are all turned off.

It should be noted that each backlight partition L also includes a plurality of backlight sub-partitions La. Each backlight sub-partition La is provided with a first light-emitting element R, a second light-emitting element G, and a third light-emitting element B. Each backlight sub-partition La adopts local dimming technology to improve display contrast of the display device. The local dimming technology can adopt the existing technology, which will not be described in detail here.

In addition, a response time of the dynamic image of the liquid crystal display panel is MPRT, MPRT=(t²±(0.8T_{f})²)^{1/2}, wherein t is the response time of the liquid crystals, and T f is the display phase. When the backlight is turned on after the liquid crystals are deflected, the response time t is equal to zero. Since each backlight partition of the embodiment of the present disclosure is in a black insertion state that does not emit light, the response time of the dynamic image MPRT is equal to 0.8×(T_{f}−scanning time-liquid crystal deflection time). The display area is divided into 6 display partitions and the backlight area is divided into 6 backlight partitions. The scanning time of the gate drive circuit in one sub-frame is 4 ms, the frequency of one sub-frame is 180 Hz, and the liquid crystal deflection time is 3 ms, the dynamic image response time MPRT=0.8×(1000/180 ms−4 ms/6−3 ms)=1.4 ms, that is, the dynamic image response time MPRT is 1.4 ms. By increasing the liquid crystal deflection time, while a smaller dynamic image response time MPRT can be obtained, the display effect of the display panel can be made better.

The present disclosure also provides a driving method for a display device. The display device includes a display panel and a backlight module, a display area of the display panel includes a plurality of display partitions arranged in sequence along a scanning direction, each of the display partitions is configured to display a corresponding partition image, and a phase of a display partition displaying the corresponding partition image includes a scanning phase, a liquid crystal deflection phase, and a light-emitting phase, a backlight area of the backlight module includes a plurality of backlight partitions arranged in sequence along the scanning direction, the plurality of backlight partitions are arranged in a one-to-one correspondence with the plurality of the display partitions, each of the plurality of backlight partitions independently provides backlight for a corresponding one of the plurality of display partitions, and each of the plurality of backlight partitions is provided with a plurality of light-emitting elements, and the driving method includes:
turning off the plurality of light-emitting elements in the backlight partitions corresponding to the plurality of display partitions in the scanning phase and the liquid crystal deflection phase when each of the plurality of display partitions displays the corresponding partition image, and turning on at least one of the plurality of light-emitting elements in the backlight partitions corresponding to the display partitions in the light-emitting phase;
wherein sub-pixels in the plurality of display partitions receive corresponding display data in the scanning phase, the display panel controls liquid crystals to deflect to a preset state according to the display data in the liquid crystal deflection phase, and backlight emitted from the plurality of backlight partitions corresponding to the plurality of display partitions passes through the liquid crystals in the preset state in the light-emitting phase to make the plurality of display partitions display the corresponding partition images.

The description of the above embodiments is only used to help understand the technical solutions and core ideas of the application, those of ordinary skill in the art should understand that: they can still modify the technical solutions recorded in the foregoing embodiments, or equivalently replace some of the technical features, and these modifications or replacements do not cause the essence of the corresponding technical solutions to deviate from the scope of the technical solutions of the embodiments of the present disclosure.

What is claimed is:

1. A display device, comprising:
a display panel, wherein a display area of the display panel comprises a plurality of display partitions arranged in sequence along a scanning direction, each of the display partitions is configured to display a corresponding partition image, and phases of each display partition displaying the corresponding partition image comprise a scanning phase, a liquid crystal deflection phase, and a light-emitting phase; and
a backlight module, wherein a backlight area of the backlight module comprises a plurality of backlight partitions arranged in sequence along the scanning direction; the plurality of backlight partitions are arranged in a one-to-one correspondence with the plurality of the display partitions, each of the plurality of backlight partitions independently provides backlight for a corresponding one of the plurality of display partitions, and each of the plurality of backlight partitions is provided with a plurality of light-emitting elements;
wherein in the scanning phase, sub-pixels in the plurality of display partitions receive corresponding display data; in the liquid crystal deflection phase, the display panel controls corresponding liquid crystals to deflect to a preset state according to the display data; and in the light-emitting phase, backlight emitted from the plurality of backlight partitions corresponding to the plurality of display partitions passes through the liquid crystals in the preset state, so that the plurality of display partitions displays corresponding partition images; and
wherein when each of the plurality of display partitions displays the corresponding partition image, the plurality of light-emitting elements in the backlight partitions corresponding to the display partition are turned off during the scanning phase and the liquid crystal deflection phase, and at least one of the plurality of light-emitting elements in the backlight partition corresponding to the display partition is turned on during the light-emitting phase.

2. The display device in claim 1, wherein a frame of the display device is divided into a plurality of different sub-frames;
each of the plurality of display partitions of the display panel sequentially displays partition images corresponding to different sub-frames in a preset order, and the corresponding partition images sequentially displayed from the plurality of display partitions of the display panel along the scanning direction form a same sub-frame.

3. The display device in claim 2, wherein the plurality of backlight partitions comprise a first backlight partition and a second backlight partition, and the first backlight partition and the second backlight partition respectively provide backlight for partition images of two different sub-frames at a same time.

4. The display device in claim 2, wherein the plurality of backlight partitions comprise a first backlight partition and a second backlight partition, and the first backlight partition and the second backlight partition respectively provide backlight for partition images of two adjacent different sub-frames of two adjacent frames at a same time.

5. The display device in claim 3, wherein the plurality of backlight partitions are the same, and at least another one backlight partition is arranged between the first backlight partition and the second backlight partition.

6. The display device in claim 2, wherein the plurality of display partitions comprise a first display partition and a second display partition, the plurality of backlight partitions comprise a first backlight partition corresponding to the first display partition and a second backlight partition corresponding to the second display partition; when the first display partition and the second display partition respectively display partition images of two different sub-frames at a same time, the light-emitting elements in the first backlight partition and the second backlight partition are turned off at a same time.

7. The display device in claim 6, wherein when the partition image displayed in the first display partition is in the liquid crystal deflection phase and the partition image displayed in the second display partition is in the scanning phase, the light-emitting elements in the first backlight partition and the second backlight partition are turned off at a same time.

8. The display device in claim 2, wherein the plurality of display partitions comprise a first display partition and a second display partition, the plurality of backlight partitions comprise a first backlight partition corresponding to the first display partition and a second backlight partition corresponding to the second display partition, and when the first display partition and the second display partition respectively display partition images of a same sub-frame at a same time, at least one of the light-emitting elements in the first backlight partition is turned on while a plurality of the light-emitting elements in the second backlight partition are turned off.

9. The display device in claim 8, wherein when the partition image displayed in the first display partition is in the light-emitting phase and the partition image displayed in the second display partition is in the liquid crystal deflection phase, at least one of the light-emitting elements in the first backlight partition is turned on while a plurality of the light-emitting elements in the second backlight partition are turned off.

10. The display device in claim 6, wherein the first display partition and the second display partition are arranged adjacent to each other.

11. The display device in claim 2, wherein each of the plurality of display partitions comprises a plurality of rows of the sub-pixels, and along the scanning direction, the plurality of rows of sub-pixels in the plurality of display partitions sequentially and successively receive display data corresponding to a same sub-frame row by row, wherein the plurality of rows of sub-pixels in each display partition receive display data of the sub-frame corresponding to the display partition.

12. The display device in claim 2, wherein a plurality of different sub-frames comprises a red sub-frame, a green sub-frame, and a blue sub-frame, and the preset order is the red sub-frame, the green sub-frame, and the blue sub-frame.

13. The display device in claim 12, wherein the display panel does not have a color filter layer, each of the plurality of display partitions comprises a plurality of rows of the sub-pixels, the plurality of sub-pixels are the same, and the plurality of sub-pixels are all square-shaped;
the plurality of light-emitting elements in each of the plurality of backlight partitions comprise a first light-emitting element emitting red light, a second light-emitting element emitting green light, and a third light-emitting element emitting blue light; and
wherein the plurality of rows of the sub-pixels in each of the plurality of display partitions receive the red light emitted by the first light-emitting element of the corresponding backlight partition to display a partition image corresponding to the red sub-frame; the plurality of rows of the sub-pixels in each of the plurality of display partitions receive the green light emitted by the second light-emitting element of the corresponding backlight partition to display a partition image corresponding to the green sub-frame; and the plurality of rows of the sub-pixels in each of the plurality of display partitions receive the blue light emitted by the third light-emitting element of the corresponding backlight partition to display a partition image corresponding to the blue sub-frame.

14. A driving method for a display device, wherein the display device comprises a display panel and a backlight module, a display area of the display panel comprises a plurality of display partitions arranged in sequence along a scanning direction, each of the display partitions is configured to display a corresponding partition image, and phases of a display partition displaying the corresponding partition image comprises a scanning phase, a liquid crystal deflection phase, and a light-emitting phase; a backlight area of the backlight module comprises a plurality of backlight partitions arranged in sequence along the scanning direction, the plurality of backlight partitions are arranged in a one-to-one correspondence with the plurality of the display partitions, each of the plurality of backlight partitions independently provides backlight for a corresponding one of the plurality of display partitions, and each of the plurality of backlight partitions is provided with a plurality of light-emitting elements, and the driving method comprises:
turning off the plurality of light-emitting elements in the backlight partitions corresponding to the plurality of display partitions during the scanning phase and the liquid crystal deflection phase when each of the plurality of display partitions displays a corresponding partition image, and turning on at least one of the plurality of light-emitting elements in the plurality of backlight partitions corresponding to the plurality of display partitions during the light-emitting phase;
wherein sub-pixels in the plurality of display partitions receive corresponding display data during the scanning phase, the display panel controls liquid crystals to deflect to a preset state according to the display data during the liquid crystal deflection phase, and backlight emitted from the plurality of backlight partitions corresponding to the plurality of display partitions passes through the liquid crystals in the preset state during the light-emitting phase to make the plurality of display partitions display the corresponding partition images.

15. The driving method in claim 14, wherein a frame of the display device is divided into a plurality of different sub-frames;
each of the plurality of display partitions of the display panel sequentially displays partition images corresponding to different sub-frames in a preset order, and the corresponding partition images sequentially displayed from the plurality of display partitions of the display panel along the scanning direction form a same sub-frame.

16. The driving method in claim 15, wherein the plurality of backlight partitions comprise a first backlight partition and a second backlight partition, and the driving method Specifically comprises providing backlight for partition images of two different sub-frames at a same time by the first backlight partition and the second backlight partition, respectively.

17. The driving method in claim 16, wherein the plurality of backlight partitions are the same, and at least another one backlight partition is arranged between the first backlight partition and the second backlight partition.

18. The driving method in claim 15, wherein the plurality of display partitions comprises a first display partition and a second display partition; the plurality of backlight partitions comprises a first backlight partition corresponding to the first display partition and a second backlight partition corresponding to the second display partition; and the driving method Specifically comprises:
turning off light-emitting elements in the first backlight partition and the second backlight partition at a same time when the first display partition and the second display partition respectively display partition images of two different sub-frames at a same time.

19. The driving method in claim 15, wherein a plurality of different sub-frames comprises a red sub-frame, a green sub-frame, and a blue sub-frame; and the preset order is the red sub-frame, the green sub-frame, and the blue sub-frame.

20. The driving method in claim 19, wherein the display panel does not have a color filter layer, each of the plurality of display partitions comprises a plurality of rows of the sub-pixels, the plurality of sub-pixels are the same, and the plurality of sub-pixels are all square-shaped;
the plurality of light-emitting elements in each of the plurality of backlight partitions comprises a first light-emitting element emitting red light, a second light-emitting element emitting green light, and a third light-emitting element emitting blue light; and
wherein the plurality of rows of the sub-pixels in each of the plurality of display partitions receive the red light emitted by the first light-emitting element of the corresponding backlight partition to display a partition image corresponding to the red sub-frame; the plurality of rows of the sub-pixels in each of the plurality of display partitions receive the green light emitted by the second light-emitting element of the corresponding backlight partition to display a partition image corresponding to the green sub-frame; and the plurality of rows of the sub-pixels in each of the plurality of display partitions receive the blue light emitted by the third light-emitting element of the corresponding backlight partition to display a partition image corresponding to the blue sub-frame.
